(19) United States
(12) Patent Application Publication
(10) Pub. No.: US 2014/0182873 A1
(43) Pub. Date: Jul. 3, 2014

(54) TOOL CHUCKING DEVICE

(71) Applicants: Marcel Fankhauser, Bern (CH); Bruno Luescher, Zofingen (CH)

(72) Inventors: Marcel Fankhauser, Bern (CH); Bruno Luescher, Zofingen (CH)

(73) Assignee: Robert Bosch GmbH, Stuttgart (DE)

(21) Appl. No.: 14/115,546

(22) PCT Filed: Mar. 9, 2012
(86) PCT No.: PCT/EP2012/054123

§ 371 Date: Feb. 7, 2014

(30) Foreign Application Priority Data
May 4, 2011 (DE) 10 2011075 228.5

(51) Int. Cl. B23Q 3/12; B25F 5/00

(52) U.S. Cl. CPC B23Q 3/12; B25F 5/00
USPC 173/213; 279/141

(57) ABSTRACT

A tool chucking device, in particular an oscillation tool chucking device, includes a tool holder that has a first form locking element and a second form locking element. The form locking elements are provided at least for a form locking connection to a machining tool in a circumferential direction about a rotational machining axis. The form locking elements are mounted rotatably with respect to each other at least relative to a rotational axis that is oriented at least substantially parallel to the rotational machining axis and/or are mounted movably with respect to each other along at least one movement axis that is oriented at least substantially perpendicular relative to an axis that is parallel to the rotational machining axis.

### PRIOR ART

There are already known tool clamping devices having a tool receiver that has a first and a second form-closure element, which are each provided for form-closure connection to a working tool in a circumferential direction, about a working rotation axis.

### DISCLOSURE OF THE INVENTION

The invention is based on a tool clamping device, in particular an oscillating-tool clamping device, having a tool receiver that has at least a first and a second form-closure element, which are each provided at least for form-closure connection to a working tool in a circumferential direction, about a working rotation axis.

It is proposed that the form-closure elements be mounted so as to be rotatable with respect to each other, at least in respect of a rotation axis oriented at least substantially parallelwise in relation to the working rotation axis, and/or be mounted so as to be movable with respect to each other along at least one movement axis oriented at least substantially perpendicularly relative to an axis that is parallel to the working rotation axis. Preferably, the rotation axis corresponds, at least substantially, to the working rotation axis. A “tool receiver” is to be understood to mean, in particular, an arrangement of components that is provided, in at least one operating state, to receive a working tool and to fix and preferably chuck the same, in particular in at least one, advantageously in at least two, movement directions, and preferably in each movement direction. In particular, the tool receiver is constituted by components of the tool clamping device that, in an operating state with a received working tool, are in direct contact with the working tool. A “working tool” is to be understood to mean, in particular, a tool for performing work by removal of material. A “working rotation axis” is to be understood to mean, in particular, a rotation axis and/or swivel axis of the tool receiver, at least in one operating state with a chucked working tool. That the working tool is connected to a form-closure element in a form-closing manner in the “circumferential direction” about a working rotation axis is to be understood to mean, in particular, that the form-closure element and the working tool each have at least one form-closure means, which preferably engage in each other and, in particular, in an operating state with a working tool inserted in the tool receiver, and at least in one operating state with a working tool chucked in the tool receiver, contact each other. Preferably, a rotation of the working tool inserted in the tool receiver, or of the form-closure means, by an angle of at least 2°, advantageously of at least 1°, preferably of at least 0.5°, causes a rotation of the respectively other part. That the two axes are “substantially parallel” is to be understood to mean, in particular, that a straight line, oriented parallelwise in relation to the one axis, and the other axis intersect in at least one point and have an angle of intersection that, in particular, is less than 10°, advantageously less than 5°, and preferably less than 1°. That the two axes are “substantially perpendicular” is to be understood to mean, in particular, that the two axes intersect in at least one point and have an angle of intersection that differs from 90° by less than 10°, advantageously less than 5°, and preferably less than 1°. That the two axes “substantially correspond” is to be understood to mean, in particular, that they are substantially parallel and, at the point at which they are closest to each other, have a distance that is less than 5 mm, advantageously less than 2 mm, and preferably less than 0.5 mm. In particular, efficiency of the oscillating tool can be increased. In particular, it is possible to achieve a fastening that is non-dependent on production tolerances of the mutually engaging form-closure means of the working tool and/or of the form-closure elements. In particular, efficiency can be increased. Advantageously, it is possible to prevent a play of the working tool in respect of a rotation about the working rotation axis in the tool receiver, with the result that it is possible to prevent torque losses when the working tool is subjected to load in the circumferential direction, about the working rotation axis. Furthermore, prevention of play enables wear on the form-closure elements to be kept to a low level.

It is furthermore proposed that the tool clamping device have a limitation unit, which is provided to limit at least one degree of freedom of a rotation and/or of a movement of the form-closure elements with respect to each other. A “degree of freedom” is to be understood to mean, in particular, a direction of movement and/or of rotation in which a movement is possible. That a rotation and/or movement is “limited” is to be understood to mean, in particular, that in particular a rotation, preferably a rotation about the rotation axis, is rendered possible in a range of at least 2° and maximally 15°, advantageously maximally 10° and preferably maximally 3°, and/or a movement, preferably a movement in the direction of the working rotation axis, is rendered possible in a range of at least 0.5 mm and maximally 3 mm, advantageously maximally 2 mm, and preferably maximally 1 mm. In particular, a loss of at least one of the form-closure elements can be achieved.

In a further design, it is proposed that the tool clamping device have a clamping unit, having at least one clamping element provided at least to clamp the form-closure elements with respect to each other along the working rotation axis, in at least one operating state. A “clamping unit” is to be understood to mean, in particular, a unit that secures a working tool, by means of a form closure and/or by means of a force closure, along the working rotation axis. Preferably, the clamping element is part of the tool receiver and is provided to clamp the working tool against the first form-closure element and to clamp the latter, in turn, against the second form-closure element. Preferably, the clamping element has at least one clamping head. Preferably, at least one clamping face, provided for axial overlap with the working tool, is disposed on the clamping head. The expression “axial overlap” is intended here to define, in particular, an overlap, in particular of partial regions, of at least two components; in particular, a straight line that is parallel to the working rotation axis intersects the two components. Preferably, the clamping face of the clamping had overlaps at least one partial region of the working tool, along the working rotation axis, in an operating state in which the working tool is chucked to the tool receiver by means of the clamping head. Particularly preferably, when the clamping head is in a mounted state, the overlap can be temporarily removed, in particular for the purpose of changing the working tool and/or altering the position of the working tool. Preferably, the tool clamping device has at least one operating unit, which is provided for actuation of the clamping unit. The term “operating unit” is intended here to define, in particular, a unit having at least one operating element that can be actuated directly by an operator, and which is provided to influence and/or alter a process and/or a state of a unit coupled to the operating element, through an actuation and/or through an input of parameters. In particular, it is possible to fix a position of the form-closure elements that is free of play in respect of the working tool.

It is furthermore proposed that the tool receiver have at least one clamping-force amplification unit, which is provided at least to amplify a clamping force, transmitted via the clamping element, to a greater relative clamping force of the form-closure elements with respect to each other. Preferably, the relative clamping force serves to connect the form-closure elements in a force-closing manner, preferably in the circumferential direction and/or to clamp at least one form-closure means of at least one form-closure element to at least one form-closure means of a working tool. In particular, improved fixing of the play-free position can be achieved.

Preferably, the clamping-force amplification unit has at least one inclined face, which is disposed on at least one of the form-closure elements. An “inclined face” is to be understood to mean, in particular, a face that, at least in one operating state with a chucked working tool, is intersected at an angle of between 5° and 30°, advantageously between 10° and 20°, and preferably between 12° and 18°, by at least one axis that is parallel to the working rotation axis. This angle is additionally referred to as an “angle of inclination”. Preferably, the angle of inclination is at least substantially uniform on at least 50%, advantageously at least 70%, preferably at least 90% of the inclined face. Preferably, both form-closure elements each have at least one inclined face, which together constitute at least one pair of inclined faces, which are pressed against each other by the clamping force, at least in one operating state with a chucked working tool. A “pair of inclined faces” is to be understood to mean, in particular, two inclined faces, of different form-closure elements, whose angle of inclination differ from each other by less than 1°. Preferably, two inclined faces of a pair of sectional faces are at least substantially parallel. That two inclined faces are substantially parallel is to be understood to mean, in particular, that, at least in one operating state with a chucked working tool, at least one normal vector of the one inclined face intersects the other inclined face at least substantially perpendicularly. A relative clamping force, which corresponds to the clamping force divided by the sine of the angle of inclination, occurs at the inclined face. In particular, a simple, inexpensive clamping-force amplification can be achieved.

In a further design, it is proposed that the inclined face be realized as a cone. Preferably, one form-closure element, preferably the first form-closure element, has an inner cone, and the other form-closure element has an outer cone, which engage in each other, at least in one operating state with a mounted tool receiver. Preferably, the at least one clamping cone is provided to effect a force-closure connection between the form-closure elements. In particular, simple clamping of the form-closure elements can be achieved.

Preferably, the tool clamping device has a positioning unit, which is provided at least to define a standard relative position of the form-closure elements. A “standard relative position” is to be understood to mean, in particular, a relative position in which the form-closure elements are in an operating state, with a mounted tool receiver, that preferably differs from an operating state with an inserted and/or chucked working tool. In particular, the positioning unit is provided to move the form-closure elements, when in an operating state, with a mounted tool receiver, that differs from an operating state with an inserted and/or chucked working tool, out of a relative position that differs from the standard relative position, back into the standard relative position, in particular by the action of gravitational force. In particular, operating comfort can be increased.

In a further design, it is proposed that the positioning unit have at least one elastic element, which is provided to clamp the form-closure elements with respect to each other if their relative position differs from the standard relative position. In particular, when the tool receiver is in a mounted state, the elastic element is disposed between the form-closure elements. An “elastic element” is to be understood to mean, in particular, an element that is at least 90% composed of an elastic material, preferably a material having a modulus of elasticity of between 0.1 N/mm² and 100 N/mm², preferably between 1 and 10 N/mm², in particular of natural and/or chemically produced and/or treated rubber, latex, caoutchouc and/or a comparable material. In particular, a material of the elastic element has a Shore hardness of between 30 and 100, in particular between 45 and 90, advantageously between 60 and 80. In a further design of the invention, the elastic element is formed on to at least one of the form-closure elements and/or materially bonded to at least one of the form-closure elements. In an alternative design variant, the elastic element may be realized as a spring element, in particular as a spiral spring. The form-closure elements can thereby be reset to the standard relative position, independently of gravity.

Preferably, at least one form-closure means, which has at least one chamfer, is disposed on each of the form-closure elements. A “chamfer” is to be understood to mean, in particular, a face that has an angle of inclination of between 35° and 55°, and that preferably has a width of at least 1 mm in its least direction of main extent. In particular, the form-closure means are realized as protuberances, preferably as cams, and are provided to engage in form-closure means of a working tool that are realized as quenching means. However, an inverse realization is equally conceivable. In particular, ease of mounting the working tool can be achieved.

The invention is additionally based on a portable power tool, in particular a hand-held power tool having a spindle that can be driven in an oscillating manner, having a power-tool clamping device according to the invention. A “portable power tool” is to be understood here to mean, in particular, a power tool, in particular a hand-held power tool, that can be transported by an operator without the use of a transport machine. The portable power tool has, in particular, a mass of less than 40 kg, preferably less than 10 kg, and particularly preferably less than 5 kg. Advantageously, for an operator of the hand-held power tool, a high degree of operating comfort can be achieved.

The tool clamping device according to the invention is not intended in this case to be limited to the applications and embodiments described above and in the following. In particular, the tool clamping device according to the invention, for the purpose of implementing a functioning mode described herein, may have a number of individual means, elements, components and units that differs from a number stated herein.

### DRAWING

Further advantages are given by the following description of the drawing. The drawing shows an exemplary embodiment of the invention. The drawing, the description and the claims contain numerous features in combination. Persons skilled in the art will also expediently consider the features individually and combine them to create appropriate further combinations.

In the drawing:

FIG. 1 shows a power tool according to the invention, having a power-tool clamping device according to the invention, in a schematic representation,

FIG. 2 shows an exploded representation of a tool receiver according to the invention,

FIG. 3 shows a plan view of the tool receiver from FIG. 3 with an inserted working tool,

FIG. 4 shows a schematic representation of a section through the tool receiver from FIG. 2,

FIG. 5 shows an exploded representation of an alternative tool receiver according to the invention, and

FIG. 6 shows a schematic sectional representation through a partial region of the tool receiver from FIG. 5.

### DESCRIPTION OF THE EXEMPLARY EMBODIMENTS

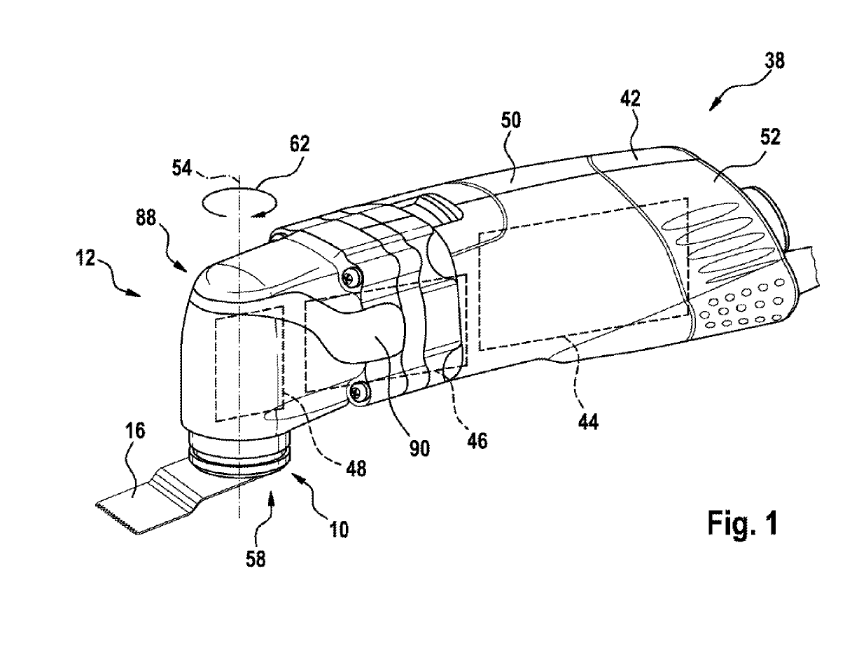

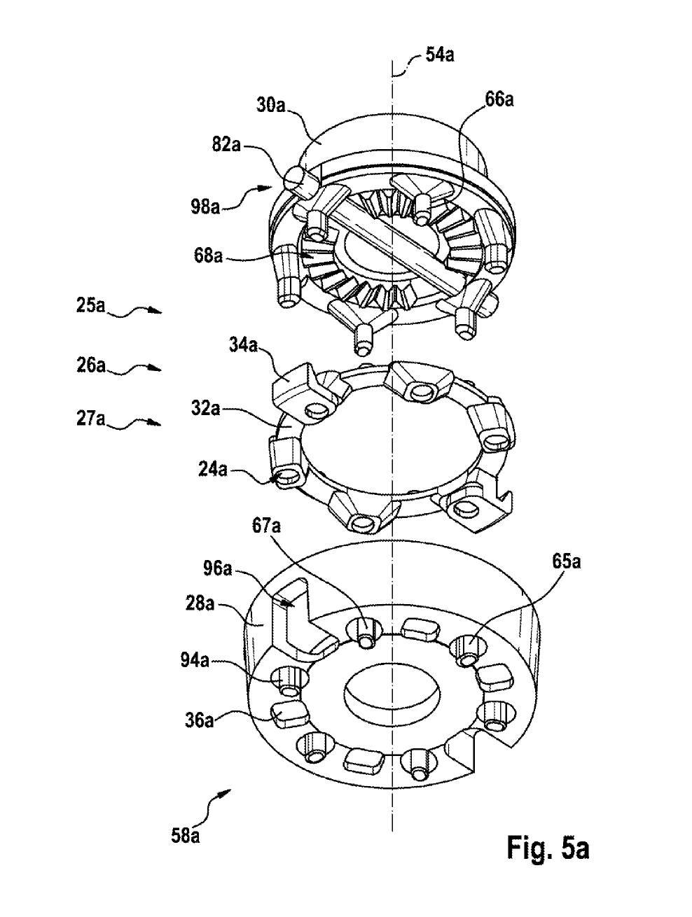

FIG. 1 shows a system, comprising an electrically operated portable power tool 38, having a tool clamping device 10 and a working tool 16. The portable power tool 38 comprises a power-tool housing 42, which encloses an electric-motor unit 44, a transmission unit 46 and an output unit 48 of the portable power tool 38. The power-tool housing 42 in this case comprises two housing half-shells 50, 52, which are separably connected to each other along a plane that runs through a working rotation axis 54. The working rotation axis 54 corresponds to a rotation axis of a spindle 40 of the output unit 48 that is realized as a hollow shaft (FIG. 4). The spindle 40 is provided, when in a mounted stated with a clamped-in working tool 16, to drive the working tool 16. The working tool 16 can be fastened to a tool receiver 58 of the output unit 48 for the purpose of performing work on workpieces by removal of material. The tool receiver has a first and a second form-closure element 28, 30, which are each provided for form-closure connection to the working tool 16 in a circumferential direction 62, about the working rotation axis 54. The second form-closure element 30 is press-fitted to the hollow shaft 56. A swivel motion of the hollow shaft 56 can thereby be transmitted to the tool receiver 58 (FIG. 4).

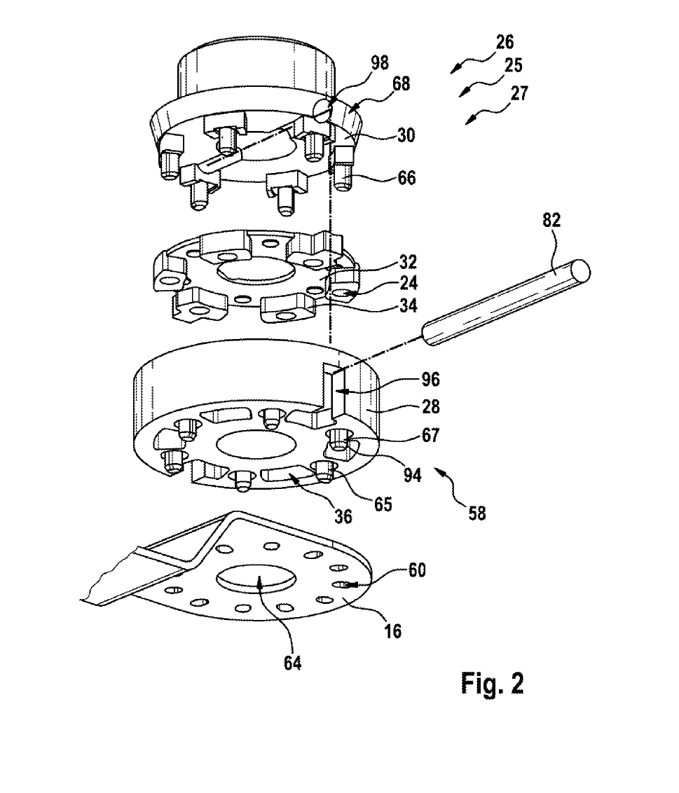

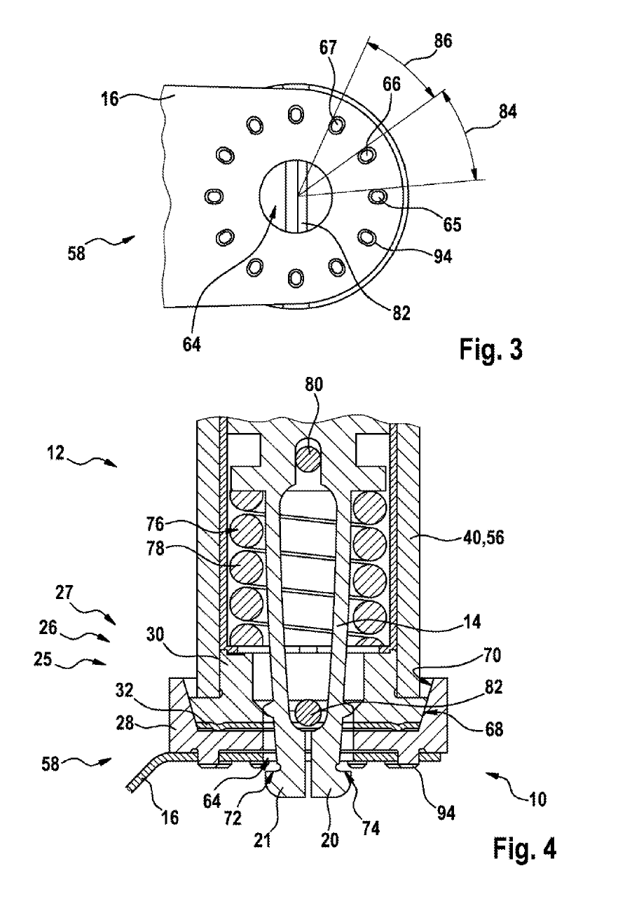

The electric-motor unit 44 disposed in the power-tool housing 42 and the transmission unit 46 are provided, when in an operating mode, to generate an oscillating swivel motion of the spindle 40, and thereby of the hollow shaft 56, in a manner known by persons skilled in the art. The oscillating swivel motion of the hollow shaft 56 is transmitted to the working tool 16 via the tool receiver 58. For the purpose of fastening the working tool 16 to the tool receiver 58 in a rotationally fixed manner, the working tool 16 has twelve form-closure means 60, realized as driving recesses, which are realized as holes and disposed in a uniformly distributed manner in a circular ring along a circumferential direction 62, on the working tool 16. The tool receiver 58 has form-closure means 65, 66, 67, which are realized as hump-type protuberances corresponding to the form-closure means 60, and which, when the working tool 16 is mounted on the tool receiver 58, extend through the form-closure means 60, along straight lines parallel to the working rotation axis 54. The form-closure means 65, 66, 67 are evenly distributed to the two form-closure elements 28, 30 (FIG. 2). When the tool receiver 58 is in a mounted state, the form-closure means 65, 66, 67 are disposed alternately in a circular ring along the circumferential direction 62 (FIGS. 2, 3).

For the purpose of chucking the working tool 16, the portable power tool 38 comprises the power-tool clamping device 10 (FIG. 4). The power-tool clamping device 10 comprises a clamping unit 12, which has a clamping element 14 provided, when in a clamping mode, to chuck the working tool 16 against the tool receiver 58 along the working rotation axis 54, and to clamp the form-closure elements 28, 30 with respect to each other along the working rotation axis 54. In addition, the clamping unit 12 has clamping heads 20, 21, which are disposed on the clamping element 14. Along the working rotation axis 54, the clamping element 14 has a greater extent than the hollow shaft 56. When in a mounted state, the clamping element 14 extends through the hollow shaft 56. The clamping element 14 in this case extends beyond the hollow shaft 56 at an end of the hollow shaft 56 that faces toward the working tool 16. The clamping element 14 likewise extends beyond the hollow shaft 56 at an end of the hollow shaft 56 that faces away from the working tool 16. When a working tool 16 has been inserted in the tool receiver 58, the clamping element 14 extends, furthermore, through a mounting recess 64 of the working tool 16, through holes disposed centrally and in a circular manner in the form-closure elements 28, 30. The hole in the second form-closure element 30 in this case is realized in two stages. In a mounted state, starting from the clamping head, the hole in the second form-closure element 30, as viewed from the clamping heads 20, 21, has a diameter that corresponds to a constant diameter of the hole in the first form-closure element. After a short distance, the hole widens with a 45° inclination to a larger diameter, and is then continued with a constant diameter.

In addition, the clamping unit 12 has an operating unit 88 for actuation of the clamping element 14. For the purpose of actuating the clamping unit 12, the operating unit 88 has an operating lever 90, which is mounted so as to be rotatable about a rotation axis that is coaxial with the working rotation axis 54 of the hollow shaft 56. It is also conceivable, however, for the operating lever 90 to be mounted, additionally, such that it can be swiveled about a swivel axis that is at least substantially perpendicular to the working rotation axis 54. By means of a mechanism known to persons skilled in the art, the operating unit 88 converts a movement of the operating lever 90 into a translational movement of the clamping element 14 along the working rotation axis 54. In a clamping position, in which the operating lever 90 bears against the power-tool housing 42, the operating unit 88 is decoupled from the clamping element 14 and from the hollow shaft 56. The clamping element 14 is realized as an expanding element (cf. FIG. 4). In this case, an end of the clamping element 14 on the clamping-head side is realized in the shape of a tuning fork, having two long prongs, and continued as a round stem at a contact point of the prongs. One of the clamping heads 20, 21 is disposed, respectively, at ends of the two prongs of the clamping element 14. If the clamping element 14 is moved into a release position as a result of an actuation of the operating unit 88, the prongs are pressed together, owing to the fact that lugs disposed on the prongs are guided, on the slopes of the hole in the second form-closure element 30, from a large diameter to a smaller diameter. As a result, the clamping heads 20, 21 are likewise moved toward the working rotation axis 54. Axial overlaps of clamping faces 72, 74, disposed on the clamping heads 20, 21, with a working tool 16 inserted in the tool receiver 58 are thereby removed (FIG. 4), and the working tool 16 is released. Conversely, in the case of a clamping operation, the lugs disposed on the prongs are guided from a small diameter to a larger diameter. The prongs in this case spread apart, owing to an internal stress built up during a release operation. The clamping heads 20, 21 establish axial overlaps with a working tool 16 inserted in the tool receiver 58, and finally press the working tool 16 against the tool receiver 58.

FIG. 2 shows an exploded representation of the tool receiver 58. The form-closure means 65, 66, 67 are evenly distributed to the two form-closure elements 28, 30. When the tool receiver 58 is in a mounted state, the form-closure means 65, 66, 67 are disposed alternately in a circular ring along the circumferential direction 62. Each of the form-closure elements 28, 30 has six form-closure means 65, 67 and 66, respectively. The form-closure means 65, 67 and 66, respectively, are in each case disposed in a regular manner, in a circular ring along a circumferential direction 62, on the corresponding form-closure element 28 and 30, respectively. The form-closure means 65, 66, 67 are integral with the form-closure elements 28, 30. The form-closure means 65, 66, 67 are integral with the form-closure elements 28, 30. The form-closure means 65, 66, 67 are disposed, as cams having an oval cross section, at an end that in each case faces away from the form-closure element 28, 30. The form-closure means 66 of the form-closure element 30 additionally have a slightly domed, cuboid-type block, which is disposed between the oval part and the form-closure element 30. All of the twelve form-closure means 65, 66, 67 have a chamfer 94. The chamfer 94 is disposed at the oval end of the form-closure means 65, 66, 67 and has an angle of inclination, relative to the form-closure means 65, 66, 67, of 45°, and a least extent of 1 mm.

When the tool receiver 58 is in a mounted state, the form-closure elements 28, 30 are mounted so as to be rotatable with respect to each other, in respect of a rotation axis that corresponds to the working rotation axis 54. The tool receiver 58 has a clamping-force amplification unit 25, which is provided to amplify a clamping force, transmitted via the clamping element 14, to a greater relative clamping force of the form-closure elements 28, 30 with respect to each other. The form-closure element 28 in this case is realized in the manner of a pot, and consists of a round base plate and a ring that is integrally formed on to the base plate on one side. An outer diameter of the ring corresponds to a diameter of the base plate. In its center, the base plate has a circular hole, through which clamping element extends when in a mounted state. The form-closure means 65, 67 are disposed on a side of the base plate that faces away from the ring. Disposed in a circular ring in the base plate, between the form-closure means 65, 67, there are six recesses 36, through which the form-closure means 66 of the form-closure element 30 extend when in a mounted state. The form-closure element 30 is realized as a base plate having a superposed ring. An outer diameter of the superposed ring is significantly smaller than a maximum diameter of the circular base plate, and corresponds to an inner diameter of the hollow shaft 56, to which the form-closure element 30 is press-fitted (FIG. 4). A maximum diameter of the base plate of the form-closure element 30 is smaller than a maximum inner diameter of the ring of the form-closure element 28. The rim of the base plate of the form-closure element 30 and an inner wall of the ring of the form-closure element 28 constitute the clamping-force amplification unit 25. The clamping-force amplification unit 25 has two inclined faces 68, 70, each respectively disposed on different form-closure elements 28, 30. The inclined faces 68, 70 are constituted by the inner wall and the rim, and are realized as cones. The inclined faces 68, are realized as an inner and an outer cone, respectively. In this case, a minimum diameter of the rim is somewhat larger than a minimum diameter of the inner wall. The inclined faces 68, 70 have the same angle of inclination, such that, in a clamping state, in which the form-closure elements 28, 30 are clamped with respect to each other, the rim bears flatly against the inner wall. In a clamping state, the angle of inclination of the inclined faces 68, 70 is 15° relative to a straight line that intersects the inclined faces 68, 70 and that is parallel to the working rotation axis 54. In the clamping state, the clamping force is converted by the inclined faces 68, 70 into a multiplicity of partial relative clamping forces, which are each perpendicular to the inclined faces 68, 70 and add up to an effective relative clamping force with which the inclined faces 68, 70 act upon each other. The relative clamping force is four times the clamping force, corresponding to the reciprocal of the sine of 15°. A force closure between the form-closure element 28, 30 that is caused by the clamping force is thus likewise amplified in comparison to a design without a clamping-force amplification unit 25, in which only two faces of the form-closure elements 28, 30, which each lie in a plane on which the working rotation axis 54 is vertical, are clamped with respect to each other.

The tool receiver 58 has a limitation unit 26, which is provided to limit a movement latitude of a rotation and of a movement of the form-closure elements 28, 30 in respect of each other. The limitation unit 26 in this case has, respectively, two holes 96, 98 disposed diametrically in the form-closure elements 28, 30, and a pin 82. The pin 82 is of a length that corresponds to the outer diameter of the form-closure element 28. In a mounted state, the holes 96, 98 overlap, and the pin 82 extends through the four holes 96, 98. The holes 98 are of a diameter that corresponds to a diameter of the pin 82. The holes 96 are of a diameter that is 1 mm greater than the diameter of the pin 82. The first form-closure element 28 can thus be moved in a small angular range about the form-closure element 30, until a delimitation of the holes 96 comes against the pin 82. Likewise, in a mounted state, a movement of the form-closure element 28 against the form-closure element 30 along the working rotation axis 54 is limited to a distance of 1 mm.

Furthermore, the tool receiver 58 has a positioning unit 27, which is provided to define a standard relative position of the form-closure elements 28, 30. The positioning unit 27 has an elastic element 32, which is provided to clamp the form-closure elements 28, 30 with respect to each other if their relative position differs from the standard relative position. When in a mounted state, the positioning unit 27 is disposed between the form-closure elements 28, 30. The elastic element 32 is composed of a soft rubber, and is realized substantially as a washer. The elastic element 32 is made of a single material. The material of which the elastic element 32 is made has a Shore hardness of 70. A maximum outer diameter of the elastic element 32 corresponds to the minimum outer diameter of the base plate of the form-closure element 30.

A rim of the elastic element 32 is likewise conical in form. The elastic element 32 has six protrusions 34, realized as pockets having a hole 24, which are provided to receive the form-closure means 66 of the form-closure element 30. When in a mounted state, the protrusions 34 each respectively surround the slightly domed, cuboid-type blocks of the form-closure means 66, and the oval ends 66 of the form-closure means extend through the holes 24. The protrusions 34, in turn, are received by the recesses 36 of the form-closure element 28. In the circumferential direction 62, a protrusion 34 of the elastic element 32 is disposed at each point between the form-closure elements 28, 30. In a mounted state, respectively one side, in the clamping mode, and, in a released mode, both sides of the protrusions 34 bear against both form-closure elements 28, 30 in the circumferential direction 62.

In principle, the elastic element 32 can be materially bonded, in particular adhesive-bonded or welded, to the form-closure element 28 and/or to the form-closure element 30.

In FIG. 3, the tool receiver 58, with an inserted working tool 16, is in a view in which the tool receiver 58 is disposed behind the working tool 16. In the standard relative position, which, when the tool receiver 58 is in a mounted state, is assumed in an operating state that differs from an operating state with an inserted working tool 16, the form-closure elements 28, 30, owing to the configuration of the protrusions 34, the recesses 36 and the form-closure means 66, are positioned in such a manner that, in a mounted state, an angle 86 between a form-closure means 67 of the form-closure element 28 and an adjacent form-closure means 66 of the form-closure element 30 is greater, by 1°, than an angle 84 between the form-closure means 66 and a form-closure means 65 of the form-closure element 28. The form-closure means 65, in turn, is adjacent to the form-closure means 66, and differs from the form-closure means 67. A sum of the angles 84, 86 between the form-closure means 65, 67 is 60°. If a working tool 16 is inserted in the tool receiver 58, the form-closure means 60 first encompass tips of the form-closure means 65, 66, 67. The form-closure means 60 are likewise oval in form and, in order to take account of production inaccuracies, are realized so as to be minimally larger than the oval ends of the form-closure means 65, 66, 67. The form-closure means 60 are disposed uniformly in the working tool 16, at angular distances of 30°. Owing to the chamfers 94, when the working tool 16 is pushed further on to the tool receiver 58, the form-closure element 28 is rotated relative to the form-closure element 30, until the angles 84, 86 differ from each other only to such an extent, for example by 0.2°, that the working tool 16 can be pushed fully on to the tool receiver 58. In this case, the elastic element 32 builds up a slight tension between the form-closure elements 28, 30. The form-closure means 60 thereby encompass the oval form-closure means 65, 66, 67. The elastic element 32 in this case has the effect of removing a play, resulting from the fact that the form-closure means 60 are larger than the form-closure means 65, 66, 67, between the working tool 16 and the tool receiver 58, or between the form-closure means 60 and the form-closure means 65, 66, 67. A relative position that ensues when the working tool 16 is placed on differs from the standard relative position. The set relative position is fixed by a clamping operation of the clamping unit 12. Thus, instead of being determined by a force closure of the working tool 16 against the tool receiver 58, or against the clamping element 14, a maximum torque that can be exerted upon the working tool 16 without causing a relative movement of the working tool 16 against the tool receiver 58, within the play, is determined by a force closure between the form-closure elements 28, 30, which force closure is at least three times as great, owing to the clamping-force amplification unit 25. Following release of the clamping unit, the working tool 16 can be removed from the tool receiver 58. The form-closure elements 28, 30 in this case return to their standard relative position, owing to the tension of the elastic element 32.

In a further design, it is possible to dispense with the chamfers 94, in which case the form-closure means 65, 67, when in a mounted state, project further out of the tool receiver 58 than the form-closure means 66. Thus, in a first step, the working tool 16 is pushed on to the form-closure means 65, 67, in a second step the working tool 16 is rotated manually together with the form-closure element 28, in order to match positions of the form-closure means 60 to positions of the form-closure means 66, and in a third step the working tool 16 can be pushed on to the form-closure means 66. In a further design, without an elastic element 32, the play can be mutually compensated by manual rotation of the form-closure elements 28, 30 in an operating state in which the working tool 16 has been pushed onto the tool receiver 58. During chucking by means of the clamping unit 12, this relative position must be maintained manually until the chucking operation has been completed.

FIG. 4 shows a section through the tool receiver 58 and a part of the clamping unit 12 along a plane that runs through the working rotation axis 54. The spindle 40, realized as a hollow shaft 56, encompasses the ring of the form-closure element 30 and is fixedly connected to the latter. Additionally disposed in the hollow shaft 56 is the clamping element 14, realized as an expanding element, and a spring unit 76, which has a compression spring 78 realized as a spiral spring. The spring unit 76 clamps the form-closure element 30 against the clamping element 14. At a location at which the prongs of the clamping element 14 come together, the clamping element 14 is mounted on a pin 80 that is fixedly connected to the hollow shaft 56. During a mounting operation, the elastic element 32 and the form-closure element 28 are brought together with the form-closure element 30, such that the holes 96, 98 overlap. The pin 82 is guided through the overlapping holes 96, 98 and between the prongs of the clamping element 14, and fixedly connected to the form-closure element 30, being press-fitted in this case (cf. also FIG. 2). The mounting recess 64 of the working tool 16, which is disposed centrally and in a circular manner between the form-closure means 60, constitutes, with holes disposed in the form-closure elements 28, 30 and with holes disposed in the elastic element 32, a channel through which the clamping element 14 is guided. The holes in the form-closure element 28 and in the elastic element 32 are of the same diameter as the mounting recess 64. In a state with a chucked working tool 16, the clamping faces 72, 74 of the clamping heads 20, 21 in each case axially overlap regions of the working tool 16 close to the mounting recess 64.

Additionally conceivable are designs in which the spring unit 76 is constituted by other types of spring, for example a stack of disc springs. Also known are alternative designs of the clamping unit 12 and, in particular, of the clamping element 14, that are compatible with the presented design of the tool receiver 58.

In further design configurations, it is conceivable for the form-closure elements 28, 30 to be shaped in the manner of a slide, wherein one of the form-closure elements 28, 30 has straight guide means that serve to guide the other form-closure element 28, 30, and for the form-closure elements to be mounted so as to be movable with respect to each other along a movement axis, which is oriented perpendicularly relative to an axis that is parallel to the working rotation axis.

Additionally conceivable are designs in which there are cams disposed on the working tool 16, which engage in form-closure means of the form-closure elements 28, 30 that are realized as driving recesses, and/or in which the form-closure means 60 are disposed in an irregular manner on the working tool 16 and/or the form-closure means 65, 66, 67 are disposed in an irregular manner on the form-closure elements 28, 30, in particular in order to prescribe a fitting position of the working tool 16.

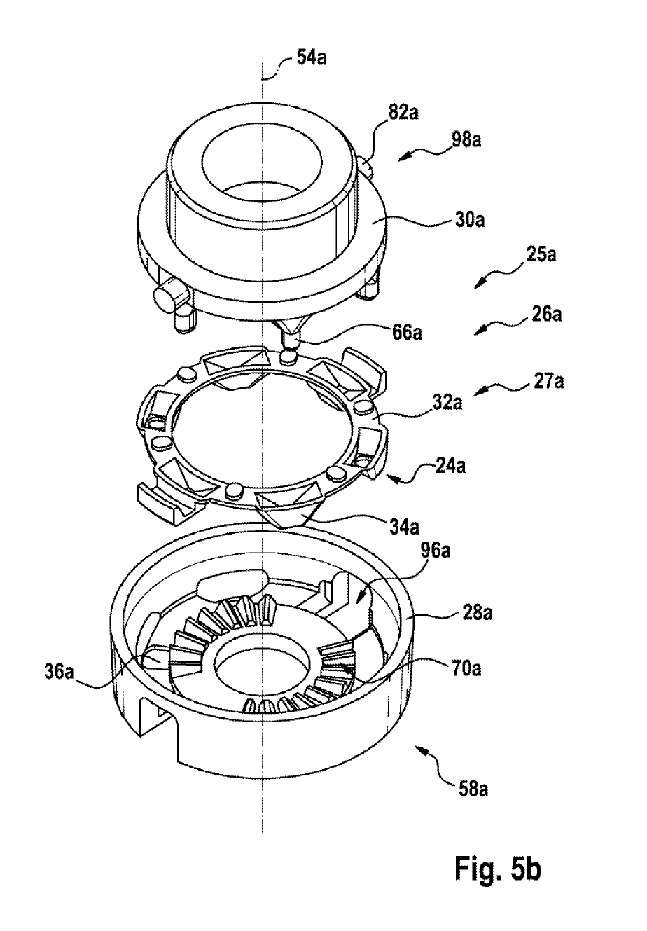

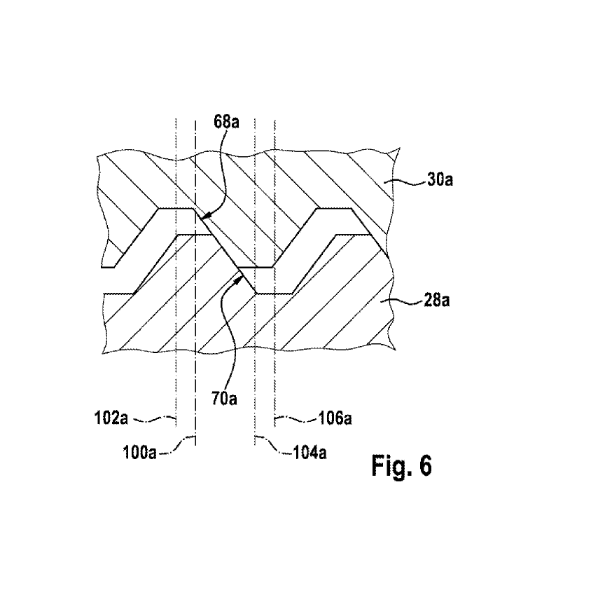

FIGS. 5a, 5b and 6 show a further exemplary embodiment of the invention. The descriptions that follow are limited substantially to the differences between the exemplary embodiments and, in principle, reference may also be made to the drawings and/or to the descriptions of the exemplary embodiment of FIGS. 1 to 4 in respect of components designated in the same manner, in particular with regard to components having the same reference numerals. To differentiate the exemplary embodiments, the letter a has been appended to the reference numerals of the further exemplary embodiment.

FIGS. 5a and 5b shows an alternative design of the tool receiver 58. The tool receiver 58a still has two form-closure elements 28a, 30a, each having six form-closure means 65a, 67a and 66a, respectively, an elastic element 32a and a pin 82a. The components are each represented in an exploded oblique view from beneath (FIG. 5a) and from above (FIG. 5b). A rim of a base plate of the form-closure element 30a and an inner wall of a ring of the form-closure element 28a, when in a mounted state, are shaped such that they are parallel to a working rotation axis 54a. The slightly domed, cuboid-type blocks of the form-closure means 66 have been replaced by slightly domed, prism-type blocks of the form-closure means 66a. The protrusions 34a, realized as pockets, of the elastic element 32a and the recesses 36a in the form-closure element 28a have been correspondingly adapted in shape. Instead of the inclined surfaces 68, 70 of the form-closure elements 28, 30 that are realized as cones, the form-closure elements 28a, 30a each have a toothed structure, disposed in a ring between the form-closure means 66a (see Figure a page) and the recesses 36a (see Figure b page), respectively, and a hole in the center of the form-closure elements 28a, 30a. The toothed structures are provided to engage in each other when in a mounted state. For this purpose, the elastic element 32a is realized as a narrow ring. The toothed structures each have a multiplicity of adjacently disposed ridges, wherein the ridges of the form-closure element 30a are each constituted by two inclined faces 68a and a top face, and the ridges of the form-closure element 28a are each constituted by two inclined faces 70a and a top face, wherein the top face is disposed in a plane that, in a mounted state, is perpendicular to the working rotation axis 54a. The inclined faces 68a, 70a each have an angle of 75° in relation to the top face.

FIG. 6 shows a section through the toothed structures when in a mounted state. The ridges of the toothed structure of one of the form-closure elements 28a, 30a each intermesh with ridges of the other form-closure element 28a, 30a. In a standard relative position, inclined faces the 68a, 70a bear against each other in pairs, and a center 100a, 104a is located 0.5 mm next to a center 102a, 106a of a trough between the opposing ridges. In this standard relative position, the form-closure means 65a, 66a, 67a of the form-closure elements 28a, 30a are disposed uniformly, at angular distances of 30°. In the case of a clamping operation with an inserted working tool, the form-closure elements 28a, 30a are moved toward each other, owing to a clamping force of a clamping element along the working rotation axis 54a. Owing to the inclined faces 68a, 70a bearing against each other, this movement is converted into a rotation of the form-closure element 28a about the working rotation axis 54a. The elastic element 32a in this case builds up a slight tension between the form-closure elements 28a, 30a. If an existing play is compensated, this state is fixed by the clamping force. Upon release of the clamping force, the tension of the elastic element 32a causes a rotation of the form-closure element 28a, which rotation restores the play and releases the working tool 16a.

1. A tool clamping device, comprising:
a tool receiver having at least a first form-closure element and a second form-closure element, the form-closure elements being configured for form-closure connection to a working tool in a circumferential direction, about a working rotation axis,
wherein the form-closure elements are mounted so as to be one or more of (i) rotatable with respect to each other at least in respect of a rotation axis oriented at least substantially parallelwise in relation to the working rotation axis and (ii) movable with respect to each other along at least one movement axis oriented at least substantially perpendicularly relative to an axis that is parallel to the working rotation axis.

2. The tool clamping device as claimed in claim 1, further comprising a limitation unit configured to limit at least one movement latitude of one or more of a rotation of the form-closure elements and a movement of the form-closure elements with respect to each other.

3. The tool clamping device as claimed in claim 1, further comprising a clamping unit, having at least one clamping element configured at least to clamp the form-closure elements with respect to each other along the working rotation axis, in at least one operating state.

4. The tool clamping device as claimed in claim 3, wherein the tool receiver has at least one clamping-force amplification unit configured at least to amplify a clamping force transmitted via the clamping element to a greater relative clamping force of the form-closure elements with respect to each other.

5. The tool clamping device as claimed in claim 4, wherein the clamping-force amplification unit has at least one inclined face disposed on at least one of the form-closure elements.

6. The tool clamping device as claimed in claim 5, wherein the inclined face is configured as a cone.

7. The tool clamping device as claimed in claim 1, further comprising a positioning unit configured at least to define a standard relative position of the form-closure elements.

8. The tool clamping device as claimed in claim 7, wherein the positioning unit has at least one elastic element configured to clamp the form-closure elements with respect to each other if their relative position differs from the standard relative position.

9. The tool clamping device as claimed in claim 1, wherein at least one form-closure means mechanism having at least one chamfer, is disposed on each of the form-closure elements.

10. A tool receiver of a tool clamping device as claimed in claim 1.

11. A portable power tool, comprising:
at least one tool clamping device including:
a tool receiver having at least a first form-closure element and a second form-closure element, the form-closure elements being configured for form-closure connection to a working tool in a circumferential direction about a working rotation axis,
wherein the form-closure elements are mounted so as to be one or more of (i) rotatable with respect to each other at least in respect of a rotation axis oriented at least substantially parallelwise in relation to the working rotation axis and (ii) movable with respect to each other along at least one movement axis oriented at least substantially perpendicularly relative to an axis that is parallel to the working rotation axis.

12. A system, comprising:
at least one portable power tool having at least one tool clamping device, the tool clamping device including:
a tool receiver having at least a first form-closure element and a second form-closure element, the form-closure elements being configured for form-closure connection to a working tool in a circumferential direction about a working rotation axis,
wherein the form-closure elements are mounted so as to be one or more of (i) rotatable with respect to each other at least in respect of a rotation axis oriented at least substantially parallelwise in relation to the working rotation axis and (ii) movable with respect to each other along at least one movement axis oriented at least substantially perpendicularly relative to an axis that is parallel to the working rotation axis; and
at least one working tool configured to chuck in the tool clamping device of the portable power tool.

13. The tool clamping device as claimed in claim 1, wherein the tool clamping device is configured as an oscillating-tool clamping device.

14. The portable power tool as claimed in claim 11, further comprising a spindle configured to be driven in an oscillating manner.
